(19) United States
(12) Patent Application Publication
(10) Pub. No.: US 2026/0320191 A1
(43) Pub. Date: Oct. 15, 2026

(54) System and method for detecting and mitigating malware threats based on threat metadata

(71) Applicant: Bank of America Corporation, Charlotte, NC (US)

(72) Inventors: Scott Fennell, Indian Land, SC (US); Jennie Kathleen Egbert, Ventura, CA (US)

(21) Appl. No.: 19/175,377

(22) Filed: Apr. 10, 2025

(51) Int. Cl. G06F 21/57; G06F 21/54; G06F 21/55; G06F 21/56

(52) U.S. Cl. CPC G06F 21/577; G06F 21/54; G06F 21/554; G06F 21/564

(57) ABSTRACT

A system for detecting and mitigating malware threats based on threat metadata. The system collects a first data set and a second data. The system creates a first training set, which includes the first data set, the second data set, and a modified first data set. The system further trains an artificial intelligence (AI) algorithm in the first stage using the first training set and retrains the AI algorithm in the second stage using a second training set. The system electronically receives threat metadata from one or more web data sources and executes the AI algorithm with the threat metadata as input to identify one or more new threats associated with one or more security policies as output.

### TECHNICAL FIELD

The present disclosure relates generally to malware threat detection, and more specifically to a system and method for detecting and mitigating malware threats based on threat metadata.

### BACKGROUND

The current malware detection techniques are not configured to identify malware threats associated with security policies before an attack. In one example, a malware attack on an organizational resource (e.g., a data server) of an organization because of a security failure (i.e., a lapse in security policy) may result in a data breach that is detected after the attack has performed the data breach. The data breach may include an unauthorized installation of a malicious software program on an organizational resource. Further, the malicious software program performs malicious activities to disrupt the operation of the organizational resource by creating unwanted files to slow down the speed and performance of the organizational resource, corrupting files, or crashing some software or executable applications so that they cannot be executed. Current malware detection techniques lack the capability to detect malware threats before an attack and apply security measures that avoid or prevent lapses in the security policy that may lead to the malware attack.

### SUMMARY

The disclosed system, described in the present disclosure, is particularly integrated into a practical application for improved protection of organizational resources from malware threats. This practical application provides several technical advantages, including utilizing an artificial intelligence (AI) algorithm that dynamically adapts to new and emerging malware threats identified from web data sources and proactively scans security policies associated with organizational resources to identify vulnerabilities in the security policies. These vulnerabilities in the security policies are mitigated by eliminating operations that cause vulnerabilities in the security policies. This results in mitigating attacks before they attack the organizational resources. The organizational resources that may be protected by the system of the present disclosure include hardware, such as mainframes, servers, networking equipment, computers, mobile devices, memory devices, and the like; software that is executed by the hardware; and/or information stored or operated upon by the hardware or software.

The current malware detection techniques are not configured to identify new types of malware threats before an attack. Specifically, the current malware detection techniques are retroactive – meaning that after the attack has done its intended damage to organizational resources, the malware is detected and addressed. The current malware detection techniques suffer from several drawbacks. For example, because the current malware detection techniques are retroactive, the security of organizational resources and information stored in the organizational resources is already compromised by the attack.

In current malware detection techniques, when organizational resources are affected by a malware attack, the attack performs harmful actions, such as system damage. System damage occurs when the malware deletes data or modifies a code of the organizational resource, leading to unstable or unusable systems. Another example of harmful action is data exfiltration. Data exfiltration occurs when the malware steals sensitive information (such as emails, passwords, financial information, etc.) stored in organizational resources. To remedy such harmful actions (i.e., system damage and data exfiltration), the affected organizational resource must be taken offline until the root problem is identified, thus making it inaccessible until the problem is identified and remedied. The disclosed system provides a technical solution to these and other technical problems in the realm of malware detection.

In some embodiments, a system for detecting and mitigating malware threats based on threat metadata includes a memory operably coupled with a processor. The memory is configured to store an artificial intelligence (AI) algorithm. The AI algorithm is trained based on an external security framework, one or more internal security requirements, one or more internal security controls, and external threat data to identify one or more threats. The processor is operably coupled to the memory and configured to collect a first data set comprising the external security framework, one or more internal security requirements, and one or more internal security controls from a database. Each of the external security framework, one or more internal security requirements, and one or more internal security controls includes one or more security policies associated with one or more organizational resources. The processor is further configured to collect a second data set comprising the external threat data, wherein the external threat data comprises one or more historical malicious operations associated with one or more security policies.

The processor is further configured to annotate one or more security policies to create a modified first data set, wherein one or more security policies are annotated with one or more annotations and wherein the one or more annotations indicate the one or more security policies that are associated with the one or more historical malicious operations. The processor further creates a first training set comprising the first data set, the second data set, and the modified first data set and trains the AI algorithm in the first stage using the first training set. The processor further creates a second training set for a second stage of training, wherein the second training set includes the first training set and incorrectly detected threats from one or more threats after the first stage of training and retrains the AI algorithm in a second stage using the second training set.

The processor is further configured to electronically receive threat metadata from one or more web data sources, wherein the threat metadata comprises a new malicious operation associated with a malicious source. The processor further executes the AI algorithm with the threat metadata as input in order to identify one or more new threats associated with the one or more security policies as output. The one or more new threats comprises a first new threat associated with a suspected security policy, wherein the suspected security policy comprises one or more resource operations that at least partially matches the new malicious operation. The processor further quarantines one or more software programs executed as part of one or more resource operations of the suspected security policy, wherein one or more software programs are quarantined by transferring one or more software programs in a quarantine sector of the memory. The processor further transforms the suspected security policy to generate a sanitized version of the suspected security policy by eliminating one or more resource operations that at least partially matches the new malicious operation, in response to quarantining one or more software programs. The processor further transfers the quarantined one or more software programs out from the quarantine sector into a software program database, in response to generating the sanitized version of the suspected security policy. The software program database is part of the one or more organizational resources.

Thus, unlike conventional systems that are unable to identify new types of malware threats before an attack, the disclosed system mitigates attacks before they attack the organizational resources by eliminating operations that cause vulnerabilities in the security policies. The vulnerabilities in the security policies may lead to malware attacks; the malware attacks perform harmful actions, such as system damage (e.g., system damage to a server device); further, it may also cause system damage to those other computing systems in communication with the server device. To remedy such harmful actions (i.e., system damage), the affected computing systems must be taken offline until the root problem is identified, thus making it inaccessible until the problem is identified and remedied. When a computing system is taken offline, it may further cause the computing systems to shut down or go offline and thus be unavailable to provide services. This leads to increased system downtime and further requires additional resources to remediate the offline computing systems, which in turn interrupts other operations that utilize the additional resources.

The disclosed system improves the protection of organizational resources from malware by proactively detecting vulnerabilities in the security policies associated with organizational resources using an AI algorithm. These vulnerabilities in the security policies are mitigated by eliminating operations that cause vulnerabilities in the security policies. Thus, the disclosed system provides a technical solution for identifying and mitigating attacks before they attack the organizational resources. Accordingly, by mitigating attacks before the attack, the harmful action of system damage is evaded, thus saving downtime associated with affected organizational resources and additionally saving resources that would otherwise be necessary to remediate affected organizational resources, which in turn provides uninterrupted operations of the organization. This leads to improved operational efficiency of organizational resources because the organizational resources are not required to be taken offline for remediation. Other examples of harmful actions that the disclosed system is able to evade before an attack may include service disruption of the organization's resources, data espionage, and identity theft.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of embodiments of the disclosure and the potential advantages thereof, reference is now made to the following written description taken in conjunction with the accompanying drawings in which:

FIG. 1 illustrates an embodiment of a system for detecting and mitigating malware threats based on threat metadata; and

FIGS. 2A-2B illustrates an example flowchart of a method of the system of FIG. 1 for detecting and mitigating malware threats.

### DETAILED DESCRIPTION

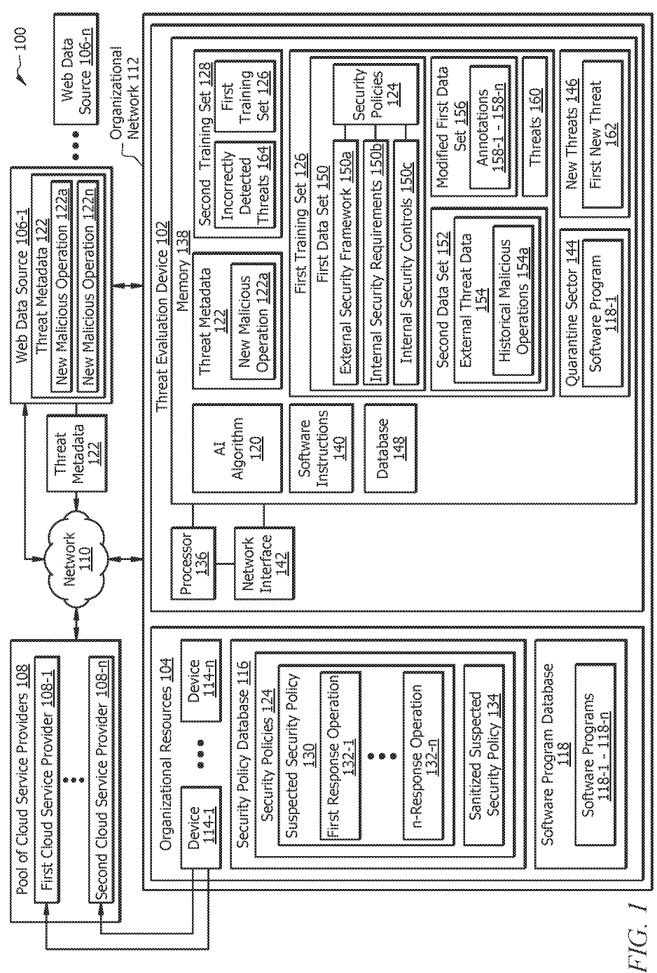

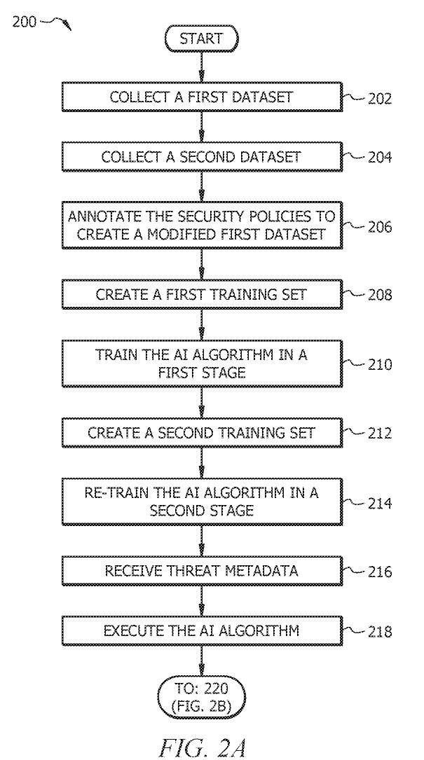

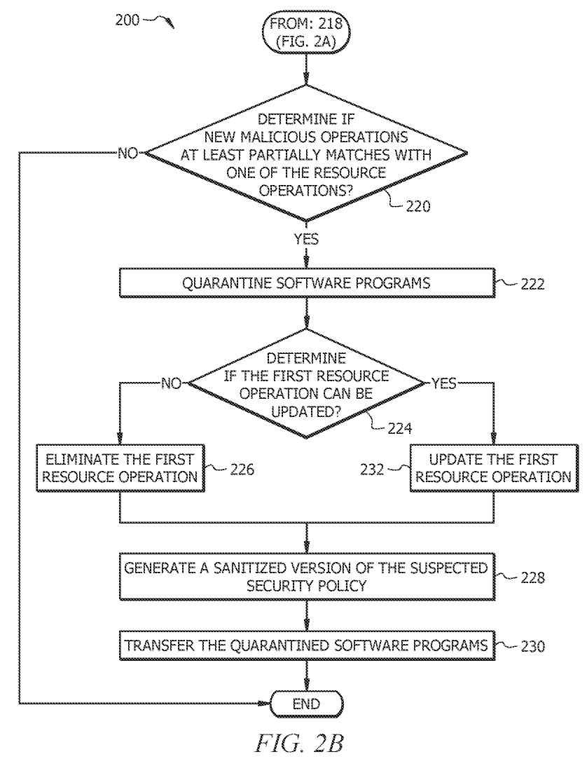

As described above, previous technologies fail to identify new types of malware threats before an attack. Embodiments of the present disclosure and its advantages may be understood by referring to FIGS. 1 through 2B. FIGS. 1 through 2B are used to describe systems and methods for detecting and mitigating malware threats based on threat metadata before an attack, according to some embodiments.

### SYSTEM OVERVIEW

FIG. 1 is a schematic diagram of a system 100, in accordance with certain aspects of the present disclosure. As shown, system 100 includes a threat evaluation device 102, organizational resources 104, web data sources 106-1 to 106-n, and a pool of cloud service providers 108-1 to 108-n operably connected to one another via a network 110. Network 110 enables communication among the components of the system 100. In other embodiments, system 100 may include other elements instead of, or in addition to, those listed above. The threat evaluation device 102 and the organizational resources 104 are part of an organizational network 112. The organizational resources 104 include devices 114-1 to 114-n, a security policy database 116, and a software program database 118. Although FIG. 1 shows a single security policy database 116, a plurality of different security policy databases 116 may also be included. The pool of cloud service providers 108-1 to 108-n are collectively also referred to as the pool of cloud service providers 108.

In general, the operation of system 100 is divided into the training of an artificial intelligence (AI) algorithm 120 and, upon the training of the AI algorithm 120, utilizing the AI algorithm 120 to identify new threats 146 (i.e., new vulnerabilities) in security policies 124. The training of AI algorithm 120 is performed based on training data (e.g., a first training set 126 and a second training set 128). Further, once the AI algorithm 120 is trained, it receives threat metadata 122 identified from web data sources 106-1 to 106-n and proactively identifies new vulnerabilities in security policies 124 of the organizational network 112. The threat metadata 122 includes new malicious operations 122a-122n. The AI algorithm 120 identifies a suspected security policy 130 of the security policies 124 that includes a first resource operation 132-1 that matches with one of the malicious operations 122a-122n (e.g., new malicious operation 122a) included in the threat metadata 122 received from the web data sources 106-1 to 106-n. The new malicious operation 122ais identified as a first new threat 162 and the first resource operation 132-1 is identified as a new vulnerability in the security policies 124. This new vulnerability is mitigated by eliminating or deleting the first resource operation 132-1 associated with the identified suspected security policy 130 to generate a sanitized suspected security policy 134 without the first resource operation 132-1. The sanitized suspected security policy 134 is a sanitized version of the suspected security policy 130 without the first resource operation 132-1.

### SYSTEM COMPONENTS

### Organizational network

The organizational network 112 includes organizational resources 104 and threat evaluation device 102 associated with an organization. The organizational network 112 is in communication with the web data sources 106-1 to 106-n and the pool of cloud service providers 108-1 to 108-n via network 110. In some embodiments, the organizational network 112 may be an internal network of the organization and may include all or a portion of a private data network, a local area network (LAN), a metropolitan area network (MAN), a wide area network (WAN), a local or regional communication or computer network, wireline or wireless network, an enterprise intranet, or any other suitable communication link, including combinations thereof, operable to facilitate communication between threat evaluation device 102 and organizational resources 104.

### Organizational resources

The organizational resources 104 include devices 114-1 to 114-n, a security policy database 116, and a software program database 118. The devices 114-1 to 114-n may generally be any device that is configured to process data. The organizational resources 104 that may be protected by the system 100 of the present disclosure include hardware, such as mainframes, servers, networking equipment, computers, mobile devices, memory devices, and the like; software that is executed by the hardware; and/or information stored or operated upon by the hardware or software. Additionally, devices 114-1 to 114-n may also include but are not limited to, a personal computer, a desktop computer, a workstation, a server, a laptop, a tablet computer, a mobile phone (such as a smartphone), an Internet-of-Things (IoT) device, or any other suitable type of device. The devices 114-1 to 114-n may include a user interface, such as a display, a microphone, a camera, a keypad, or other appropriate terminal equipment usable by a user. In an embodiment, devices 114-1 to 114-n may be database servers, application servers, or any other server devices utilized within an organization.

### Threat evaluation device

The threat evaluation device 102 includes a processor 136 in signal communication with a memory 138. Memory 138 stores software instructions 140 that when executed by processor 136, cause processor 136 to perform one or more operations of the threat evaluation device 102 described herein. The threat evaluation device 102 further includes a network interface 142.

### Processor

Processor 136 includes one or more processors. Processor 136 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors are configured to execute instructions (e.g., software instructions 140) to perform the operations of the threat evaluation device 102 described herein. The processor 136 is configured to operate as described in FIGS. 1-2B. For example, processor 136 may be configured to perform one or more operations of method 200 as described in FIGS. 2A-2B.

### Network interface

The network interface 142 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. Network interface 142 is configured to enable wired and/or wireless communications. The network interface 142 may be configured to communicate data between the threat evaluation device 102 and other devices, systems, or domains. The processor 136 may be configured to send and receive data using the network interface 142. The network interface 142 may be configured to use any suitable type of communication protocol.

### Memory

The memory 138 may be volatile or non-volatile and may comprise read-only memory (ROM), random-access memory (RAM), ternary content-addressable memory (TCAM), dynamic random-access memory (DRAM), and static random-access memory (SRAM). The memory 138 may include one or more of a local database, a cloud database, a network-attached storage (NAS), etc. The memory 138 comprises one or more disks, tape drives, or solid-state drives and may be used as an over-flow data storage device to store programs when such programs are selected for execution and to store instructions and data that are read during program execution. Memory 138 may store any of the information described in FIGS. 1-2B along with any other data, instructions, logic, rules, or code operable to implement the function(s) described herein when executed by processor 136. For example, the memory 138 may store a first training set 126, a second training set 128, software instructions 140, AI algorithm 120, threat metadata 122, quarantine sector 144, new threats 146, a database 148, and/or any other data or instructions. The software instructions 140 may include any suitable set of instructions, logic, rules, or code operable to execute the processor 136 and perform the functions described herein, such as some or all of those described in FIGS. 1-2B.

### Network

Network 110 may be any suitable type of wireless and/or wired network. The network 110 may be connected to the Internet or public network. Network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 110 may be configured to support any suitable type of communication protocol, as would be appreciated by one of ordinary skills in the art. The organizational network 112, the web data sources 106-1 to 106-n, and the pool of cloud service providers 108 communicate with each other using the network 110.

### Initiate training of AI algorithm

System 100 initiates the detection and mitigation of malware threats by training the AI algorithm 120 and then utilizing the AI algorithm 120 to identify new threats 146 (i.e., new vulnerabilities) in security policies 124. The training of AI algorithm 120 is performed based on training in the first stage by utilizing the first training set 126. The first training set 126 is created by collecting the first data set 150, collecting the second data set 152, and creating the modified first data set 156, explained in detail below.

### Collect first data set

In operation, processor 136 of the threat evaluation device 102 is configured to collect the first data set 150 from database 148. The first data set 150 includes external security framework 150a, internal security requirements 150b, and internal security controls 150c. The external security framework 150a, internal security requirements 150b, and internal security controls 150c each include security policies 124 that are utilized to protect the organizational network 112 from malware attacks. For example, security policies 124 may include a first security policy to control access to the organizational resources 104 that may be implemented by, for example, allowing access to the organizational resources 104 only through administrative user profiles. In another example, controlling access to organizational resources 104 may be implemented by, for example, allowing access to the organizational resources 104 through guest user profiles and administrative user profiles. The administrative user-profiles and guest user profiles are stored in database 148. The administrative user profiles are associated with organizational resources 104 (e.g., devices 114-1 to 114-n) that are previously authenticated or verified to access the organizational network 112.

The security policy 124 may be stored in the security policy database 116 of the organizational resources 104. Security policies 124 stored in the first training set 126 and security policies 124 stored in the security policy database 116 include the same data.

For example, the external security framework 150a may include a plurality of security frameworks associated with the organizational resources 104 (e.g., devices 114-1 to 114-n). The plurality of security frameworks may include CSA CCM framework (Cloud Controls Matrix (CCM) framework, developed by the Cloud Security Alliance (CSA)), NIST CSF framework (Cybersecurity Framework (CSF) developed by National Institute of Standards and Technology), and MITRE ATT&CK framework (MITRE Adversarial Tactics, Techniques, and Common Knowledge (ATT&CK) framework), although any other security framework may also be included. The CSA CCM framework is a cybersecurity control framework for cloud computing. For example, the CSA CCM framework may include key domains such as audit and assurance, data security and privacy, and/or identity and access management, although any other key domain associated with the CSA CCM framework may also be included. The key domains of CSA CCM framework are a part of the security policies 124. The NIST CSF framework is a set of guidelines and best practices designed to help manage and mitigate cybersecurity risks, encompassing key functions identifying, protecting, detecting, responding to, and recovering from cyber incidents. The key functions of NIST CSF framework are a part of the security policies 124. The MITRE ATT&CK framework is used to understand and categorize cyberattack behaviors. The MITRE ATT&CK framework includes a plurality of matrices that comprise the MITRE Adversarial Tactics, Techniques, and Common Knowledge (ATT&CK) framework. For example, the plurality of matrices may include Pre-ATT&CK, enterprise ATT&CK, Mobile ATT&CK, and/or industrial control systems (ICS) ATT&CK. The plurality of matrices of MITRE ATT&CK framework are part of the security policies 124.

Internal security requirements 150b may include one or more internal security framework of the organizational network 112. For example, the one or more internal security framework of the internal security requirements 150b may include one or more security frameworks (explained above) associated with the organizational resources 104 (e.g., devices 114-1 to 114-n) implemented within the organizational network 112. For example, the internal security requirements 150b may include the NIST CSF framework and the CSA CCM framework implemented within the organizational network 112. One or more security frameworks included in the internal security requirements 150b are part of the security policies 124.

Internal security controls 150c may include security controls associated with the organizational resources 104 (e.g., devices 114-1 to 114-n) of the organizational network 112. For example, the internal security controls 150c may include controlling access to the organizational resources 104 (e.g., devices 114-1 to 114-n). Internal security controls 150c are part of the security policies 124. Accordingly, each of the external security framework 150a, the internal security requirements 150b, and the internal security controls 150c includes the security policies 124 associated with the organizational resources 104.

### Collect second data set

Processor 136 of the threat evaluation device 102 is configured to collect a second data set 152 from the database 148. Database 148 is configured to store the second data set 152, including external threat data 154. The external threat data 154 includes historical malicious operations 154a (i.e., known malicious operations). The historical malicious operations 154a are associated with the security policies 124. For example, the first historical malicious operation of the historical malicious operations 154a may be associated with a first security policy of the security policies 124. The first historical malicious operation may be accessing a first organizational resource (e.g., device 114-1) from a geolocation outside of country A to perform malicious activities (e.g., data breach by hacking the device 114-1). The first security policy may be allowing access to the first organizational resource (e.g., device 114-1) from a geolocation outside country A.

### Annotate security policies

Processor 136 of the threat evaluation device 102 is configured to annotate the security policies 124 to create a modified first data set 156. The security policies 124 are annotated with annotations 158-1 to 158-n. The annotations 158-1 to 158-n indicate the security policies 124 associated with the historical malicious operations 154a. For example, the first security policy of the security policies 124 may be annotated with a first annotation 158-1 of the annotations 158-1 to 158-n. The first annotation 158-1 indicates that the first security policy is associated with the first historical malicious operation of the historical malicious operations 154a.

### Create a first training set

Upon collecting the training data (e.g., first data set 150, collecting the second data set 152, and creating the modified first data set 156), processor 136 of the threat evaluation device 102 is configured to create a first training set 126. The first training set 126 includes the first data set 150, the second data set 152, and the modified first data set 156. The AL algorithm 120 is now ready to be trained based on the first training set 126. Accordingly, the training of the AI algorithm 120 is initiated in the first stage.

### Train the AI algorithm in a first stage

Processor 136 of the threat evaluation device 102 is configured to execute the artificial intelligence (AI) algorithm 120 in a first stage with the first training set 126 as input to initiate training of the AI algorithm 120. The AI algorithm 120 detects one or more threats 160 (i.e., known threats) associated with the security policies 124 as output, during the first stage of the training. For example, one or more threats 160 detected are part of the historical malicious operations 154a (i.e., known malicious operations) provided as input. The historical malicious operations 154a are associated with the security policies 124. The training of the AI algorithm 120 in the first stage is completed here.

The AI algorithm 120 may include a support vector machine, machine learning, neural network, random forest, a large language model (LLM) algorithm, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 120 may include a data processing machine learning algorithm. The AI algorithm 120 may be implemented by supervised, semi-supervised, and/or unsupervised machine learning. In another embodiment, processor 136 executes the AI algorithm 120 to perform one or more operations to detect one or more threats 160 associated with the security policies 124. In another embodiment, processor 136 executes software instructions 140 and is configured to detect one or more threats 160 associated with security policies 124 without utilizing AI algorithm 120.

### Create a second training set

Upon completion of the first stage of training of AI algorithm 120 based on the first training set 126, the AI algorithm 120 is re-trained in a second stage. To re-train the algorithm 120 in the second stage, the system 100 collects a second training set 128, explained in detail below.

Processor 136 of the threat evaluation device 102 is configured to create a second training set 128, for a second stage of training of the AI algorithm 120. The second training set 128 includes the first training set 126 and any incorrectly detected threats 164 from one or more threats 160 determined after the first stage of training of the AI algorithm 120. The AI algorithm 120 detects one or more threats 160 as part of the first stage, some of the threats 160 may be detected incorrectly, such that the AI algorithm 120 may incorrectly detect one or more security policies 124 that are not a threat (i.e., are not vulnerable to malware attacks) to be associated with one or more of the historical malicious operations 154a. These incorrectly detected security policies 124 are then re-annotated and stored as incorrectly detected threats 164. The re-annotation indicates that the incorrectly detected security policies 124 are not associated with the historical malicious operations 154a.

### Retrain the AI algorithm in a second stage

Processor 136 of the threat evaluation device 102 is configured to execute the AI algorithm 120 in a second stage with the second training set 152 as input to initiate re-training of the AI algorithm 120 to detect one or more threats 160 (i.e., known threats) associated with the security policies 124. The second stage of re-training of the AI algorithm 120 is similar to the first stage of the training of the AI algorithm 120. Once the second stage of re-training of the AI algorithm 120 is completed, the trained AI algorithm 120 is generated. In an embodiment, re-training the AI algorithm 120 may be an iterative operation that may be performed n-number of times until the algorithm 120 achieves a threshold accuracy of detecting one or more threats 160.

### Initiate detection and mitigation of new threats

System 100 initiates the detection and mitigation new threats 146 (i.e., new vulnerabilities) in security policies 124 by utilizing the trained AI algorithm 120. The detection and mitigation of new threats 146 is performed by first receiving the threat metadata 122 from web data sources 106-1 to 106-n and input the threat metadata 122 into the AI algorithm 120 input in order to identify one or more new threats 146 associated with one or more security policies 124 as output, explained in detail below.

### Receive threat metadata from web data sources

Web data sources 106-1 to 106-n may represent any server device (e.g., web service devices) in communication with the public internet. For example, web data source 106-1 stores the threat metadata 122. The web data sources 106-1 to 106-n are configured to collect information associated with new types of malware attacks. For example, web data sources 106-1 to 106-n store information accessed through the public internet (via the network 110) to gather information for a new type of malware that may be developed by bad actors and that would, if implemented, present vulnerabilities to organizational resources 104. The gathered information may include new malicious operations 122a – 122n (i.e., new malicious attacks) performed by known or unknown malware which is stored as threat metadata 122.

Processor 136 of the threat evaluation device 102 is configured to electronically receive threat metadata 122 from web data sources 106-1 to 106-n. Threat metadata 122 includes a new malicious operation 122a, which is associated with a malicious source. The web data source 106-1 transmits the generated threat metadata 122 to the threat evaluation device 102 in the organizational network 112.

### Threat metadata

Threat metadata 122 includes new malicious operations 122a – 122n (i.e., new malicious attacks) performed by known or unknown malware. The new malicious operations 122a – 122n may be performed by malwares. For example, the malware may include a virus, a trojan horse, a macro virus, ransomware, spyware, adware, scareware, or rootkit, although any other malicious software that performs a malicious attack may also be included. For example, the new malicious operation 122a may include a new type of malicious operation performed by a new malware that may be developed by bad actors and that would, if implemented, present vulnerabilities to organizational resources 104. In an embodiment, the new malicious operation 122a is creating a temporary guest profile to gain access to a network device (i.e., of any organization). Upon gaining access to the network device the bad actors install a malware on the network device to initiate a malware attack.

In another example, new malicious operations 122a may include a new type of malicious operation performed by a known malware that has been developed by bad actors and has affected external entities (e.g., other organizations) and thus presents vulnerabilities to the organizational resources 104. The new malicious operations are referred to as threat metadata 122.

### Execute trained AI algorithm to identify new threats

Processor 136 of the threat evaluation device 102 is configured to execute the trained AI algorithm 120 with the threat metadata 122 as input in order to identify one or more new threats 146 associated with one or more security policies 124 as output. The trained AI algorithm 120 analyzes the threat metadata 122 (including a plurality of new malicious operations 122a-122n) to at least determine that the new malicious operation 122a is the first new threat 162. The AI algorithm 120 determines that the first new threat 162 corresponding with the new malicious operation 122a is associated with a suspected security policy 130 stored in the security policies 124. The suspected security policy 130 includes a plurality of resource operations 132-1 to 132-n, and the AI algorithm 120 determines that a first resource operation 132-1 at least partially matches with the new malicious operation 122a and thus determine that the new malicious operation 122a is a first new threat 162. The trained AI algorithm 120 is interchangeably also referred to as the AI algorithm 120.

An example of suspected security policy 130 is creating guest user profiles by devices outside of the organizational network 112. Such devices may not be authenticated or verified to access the organizational network 112 but would be able to access it by creating guest user profiles.

In an embodiment, upon receiving the threat metadata 122, as input, the AI algorithm 120 determines, for example, that the new malicious operation 122a is to gain access to a first organizational resource (e.g., device 114-1) of the organizational resources 104 by creating a temporary guest profile. Upon gaining access to the first organizational resource (e.g., device 114-1) the bad actors may potentially install a malware on the network device to initiate a potential malware attack. Accordingly, to stop the potential malware attack, the AI algorithm 120 identifies, as output, the suspected security policy 130 associated with controlling the creation of a temporary guest profile by the organizational resources 104 (e.g., device 114-1). Further, the suspected security policy 130 includes a plurality of resource operations 132-1 to 132-n. The plurality of resource operations 132-1 to 132-n are also referred to as a first resource operation 132-1 to n-resource operation 132-n. The resource operations 132-1 to 132-n may include any operations that the organizational resources 104 may perform within the organizational network 112. For example, a first resource operation 132-1 of the plurality of resource operations 132-1 to 132-n may include creating a temporary guest profile to gain access to a first organizational resource (e.g., device 114-1) of the organizational resources 104.

Thus, the AI algorithm 120 determines the operation of creating a temporary guest profile to gain access to the organizational network 112 is common between the first resource operation 132-1 and the new malicious operation 122a. Thus, the AI algorithm 120 determines for the suspected security policy 130 the first resource operation 132-1 at least partially matches with the new malicious operation 122a.

### Quarantine software programs

Processor 136 of the threat evaluation device 102 is configured to quarantine at least one or more of the software programs 118-1 to 118-n (stored in the software program database 118) executed as part of the first resource operation 132-1 of the suspected security policy 130. The software programs 118-1 to 118-n may include any software utilized by the organizational resources 104 to perform the resource operations 132-1 to 132-n.

In an embodiment, the first resource operation 132-1 executes a software program 118-1 (also referred to as first software program 118-1) of the plurality of the software programs 118-1 to 118-n to perform one or more operations associated with the first resource operation 132-1. For example, first resource operation 132-1 includes creating a temporary guest profile to gain access to a first organizational resource (e.g., device 114-1) of the organizational resources 104. Processor 136 determines that the software program 118-1 would be executed by the suspected security policy 130 as part of performing the first resource operation 132-1. Thus, upon creating the temporary guest profile, the first software program 118-1, is executed (i.e., launched automatically) to display user-sensitive data. Accordingly, upon determining the first resource operation 132-1 at least partially matches with the new malicious operation 122a, processor 136 quarantines the first software program 118-1 by transferring the first software program 118-1 in a quarantine sector 144 of the memory 138 from the software program database 118. Thus, the first software program 118-1, may not be launched or executed when the temporary guest profile is created.

For example, the transfer is performed by the processor 136, copying the first software program 118-1 into the quarantine sector 144 and then deleting the first software program 118-1 from the software program database 118, where it was identified. When first software program 118-1 is stored in the quarantine sector 144, first software program 118-1 is not permitted or prevented from being executed for any operation from any security policies 124 outside the quarantine sector 144. Specifically, the first resource operation 132-1 may not be able to execute the first software program 118-1 when the first software program 118-1 is quarantined in the quarantine sector 144. Thus, the first software program 118-1 is isolated in the quarantine sector 144 and any malicious attack cannot harm or attack the first software program 118-1.

### Generate a sanitized version of the suspected security policy

Once processor 136 transfers the first software program 118-1 into the quarantine sector 144, processor 136 mitigates the first new threat 162 associated with the suspected security policy 130 by transforming the suspected security policy 130 to generate a sanitized version of the suspected security policy 130 (also referred to as sanitized suspected security policy 134). Transforming the suspected security policy 130 is performed by eliminating or deleting the first resource operation 132-1 from the suspected security policy 130.

### Transfer quarantined software programs

Once processor 136 eliminates the first resource operation 132-1 from the suspected security policy 130, the sanitized version of the suspected security policy 130 is generated. This sanitized version of the suspected security policy 130 does not include the first resource operation 132-1. Accordingly, the operation of creating a temporary guest profile to gain access to the organizational network 112 is eliminated. Thus, the first new threat 162 of the new malicious operation 122a associated with the suspected security policy 130 is eliminated. Accordingly, bad actors may not be able to gain access to the first organizational resource (e.g., device 114-1) of the organizational resources 104 by creating a temporary guest profile. Thus, the malware threat associated with the new malicious operation 122a is proactively mitigated before the attack is performed. Upon generating the sanitized version of the suspected security policy 130, processor 136 transfers the quarantined first software program 118-1 out from the quarantine sector 144 back into the software program database 118 of the organizational resources 104.

### Quarantining an organizational resource

In an embodiment, in response to quarantining the first software program 118-1, processor 136 is configured to identify a first organizational resource (e.g., device 114-1) from the organizational resources 104 that accessed the first software program 118-1 within a past threshold time period. The past threshold time period may include the past 5 minutes, the past 24 hours, or the past week, although any other time period may also be included.

Further, processor 136 is configured to access a database 148 that stores an access history list associated with each of the software programs 118-1 to 118-n. The access history list includes a timestamp associated with when each of the software programs 118-1 to 118-n was accessed by each of organizational resources 104. For example, the access history list includes a first timestamp associated with when the first organizational resource (e.g., device 114-1) accessed the first software program 118-1.

Further, processor 136 is configured to determine if the first timestamp associated with the first organizational resource (e.g., device 114-1) is within a past threshold time period. For example, the first timestamp is 10 minutes since the first organizational resource (e.g., device 114-1) accessed the first software program 118-1. The past threshold time period is, for example, 15 minutes. Thus, processor 136 compares the first timestamp (10 minutes) with the past threshold time period (e.g., 15 minutes), and processor 136 determines that the first organizational resource (e.g., device 114-1) accessed the first software program 118-1 within the last 15 minutes, thus identifies the first organizational resource (e.g., device 114-1) has accessed the first software program 118-1 within the past threshold time period.

Upon processor 136 identifying that the first organizational resource (e.g., device 114-1) accessed the first software program 118-1 within the past threshold time period, then processor 136 quarantines the first organizational resource (e.g., device 114-1) by blocking access to any and all communications with the first organizational resource (e.g., device 114-1). Accordingly, the first organizational resource will not be able to perform any operations until an administrative user verifies that the first organizational resource is not affected by a malware attack.

### Pool of cloud service providers

In an embodiment, the threat metadata 122 may indicate that a first cloud service provider 108-1 may be identified as including vulnerabilities such that the first cloud service provider 108-1 is prone to a new malicious attack from a new malware. The new malicious attack may perform a malware attack when an organization resource (e.g., device 114-1) accesses the first cloud service provider 108-1. For example, the metadata 122 may include a new malicious operation 122a, and the new malicious operation 122a includes an operation of accessing a first cloud service provider 108-1 to access data stored at the first cloud service provider 108-1. When this, threat metadata 122 is input to the AI algorithm 120, then AI algorithm 120 identifies the suspected security policy 130 as output. AI algorithm 120 identifies the suspected security policy 130 as output based on determining that the suspected security policy 130 includes first resource operation 132-1 that at least partially matches with the new malicious operation 122a. For example, an operation associated with the first resource operation 132-1 is the first organizational resource (e.g., device 114-1) accessing the first cloud service provider 108-1 to exchange data.

Each of the cloud service providers 108-1 to 108n may be a private cloud, a public cloud, a combination of a private cloud and a public cloud (hybrid cloud), or the like. Each of the pool of cloud service providers 108-1 to 108n offers on-demand and scalable computing resources to the organizational resources 104, such as infrastructure, database servers, application servers, or storage servers, over the network 110.

### Updating the first resource operation

As explained above, processor 136 executes the AI algorithm 120 to determine a suspected security policy 130 associated with the new malicious operation 122a. Further, as explained above, processor 136 transforms the suspected security policy 134 to generate the sanitized version of the suspected security policy 130 by updating the first resource operation 132-1 associated with the suspected security policy 130.

The processor 136 updates the first resource operation 132-1, such that the first organizational resource (e.g., device 114-1) is blocked from accessing the first cloud service provider 108-1 for any communications and further the first organizational resource (e.g., device 114-1) is granted permission to be able to access a second cloud service provider 108-n. The updated first resource operation 132-1 causes processor 136 to access the second cloud service provider 108-n instead of the first cloud service provider 108-1.

### Method 200

FIGS. 2A-2B illustrates an example flowchart of method 200 for detecting and mitigating malware threats based on threat metadata in accordance with an embodiment of the present disclosure. For example, one or more operations of method 200 may be implemented, at least in part, in the form of software instructions 140 of FIG. 1, stored on a tangible non-transitory machine-readable medium or a computer-readable medium (e.g., memory 138 of FIG. 1) that, when run by one or more processors (e.g., processor 136 of FIG. 1) may cause the one or more processors to perform operations of the method 200.

With reference to FIG. 2A, at operation 202, processor 136 is configured to collect the first data set 150. The first data set 150 includes external security framework 150a, internal security requirements 150b, and internal security controls 150c from database 148.

At operation 204, processor 136 is configured to collect a second data set 152 from the database 148. Database 148 is configured to store the second data set 152, including external threat data 154.

At operation 206, processor 136 is configured to annotate the security policies 124 to create a modified first data set 156. The security policies 124 are annotated with annotations 158-1 to 158-n.

At operation 208, processor 136 is configured to create a first training set 126. The first training set 126 includes the first data set 150, the second data set 152, and the modified first data set 156.

At operation 210, processor 136 is configured to execute the AI algorithm 120 in a first stage with the first training set 126 as input to initiate training of the AI algorithm 120.

At operation 212, processor 136 is configured to create a second training set 128, for a second stage of training. The second training set 128 includes the first training set 126 and incorrectly detected threats 164 determined after the first stage of training of the AI algorithm 120.

At operation 214, processor 136 is configured to execute the AI algorithm 120 in a second stage with the second training set 128 as input to initiate re-training of the AI algorithm 120.

At operation 216, processor 136 is configured to electronically receive threat metadata 122 from web data sources 106-1 to 106-n. The threat metadata 122 includes a new malicious operation 122a associated with a malicious source.

At operation 218, processor 136 is configured to execute the trained AI algorithm 120 with the threat metadata 122 as input.

With reference to FIG. 2B, at operation 220, processor 136 is configured to execute the trained AI algorithm 120 to identify one or more new threats 146 associated with one or more security policies 124 as output. Specifically, AI algorithm 120 determines if one of the plurality of new malicious operations 122a-122n at least partially matches with one of the resource operations 132-1 to 132-n. For example, AI algorithm 120 determines that the first new threat 162 corresponding with the new malicious operation 122a is associated with a suspected security policy 130 stored in the security policies 124. The suspected security policy 130 includes a plurality of resource operations 132-1 to 132-n, and the AI algorithm 120 determines that a first resource operation 132-1 at least partially matches with the new malicious operation 122a and thus determines that the new malicious operation 122a is a first new threat 162. Upon determining one of the plurality of new malicious operations 122a-122n at least partially matches with one of the resource operations 132-1 to 132-n, then the method proceeds to operation 222.

At operation 222, processor 136 is configured to quarantine at least one or more of the software programs 118-1 to 118-n executed as part of the first resource operation 132-1 of the suspected security policy 130. For example, processor 136 quarantines the first software program 118-1 by transferring the first software program 118-1 in a quarantine sector 144 of the memory 138 from the software program database 118.

At operation 224, processor 136 is configured to determine if the first resource operation 132-1, which at least partially matches the new malicious operation 122a, can be updated to mitigate the threat associated with the new malicious operation 122a. For example, processor 136 determines if the first resource operation 132-1 is an operation associated with accessing one of the organizational resources 104 (e.g., device 114-1) by creating a temporary guest profile (as explained above), then the processor 136 is configured to determine that the first resource operation 132-1 cannot be updated and determines that the first resource operation 132-1 needs to be eliminated and the method 200 proceeds to operation 226.

At operation 226, processor 136 is configured to eliminate the first resource operation 132-1 from the suspected security policy 130.

At operation 228, processor 136 is configured to transform the suspected security policy 130 to generate a sanitized version of the suspected security policy 130. Transforming the suspected security policy 130 is performed by eliminating the first resource operation 132-1, which at least partially matches the new malicious operation 122a.

At operation 230, upon generating the sanitized version of the suspected security policy 130, processor 136 transfers the quarantined first software program 118-1 out from the quarantine sector 144 back into the software program database 118 of the organizational resources 104.

Back at operation 224, when processor 136 determines the first resource operation 132-1, which at least partially matches the new malicious operation 122a, can be updated to mitigate the threat associated with the new malicious operation 122a, then the method proceeds to operation 232. For example, processor 136 determines if the first resource operation 132-1 is an operation associated with accessing one of the pool of cloud service providers 108, then the processor 136 is configured to determine that the first resource operation 132-1 can be updated and the method proceeds to operation 232.

At operation 232 processor 136 is configured to update the first resource operation 132-1 from the suspected security policy 130. Next, at operation 228, processor 136 is configured to transform the suspected security policy 130 to generate a sanitized version of the suspected security policy 130. Transforming the suspected security policy 130 is performed by updating the first resource operation 132-1.

Back at operation 220, when the AI algorithm 120 determines that one of the plurality of new malicious operations 122a-122n does not partially match with one of the resource operations 132-1 to 132-n, then the method ends here.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

What is claimed is:

1. A system comprising:
a memory operable to store an artificial intelligence (AI) algorithm, wherein the AI algorithm is trained based on an external security framework, one or more internal security requirements, one or more internal security controls, and external threat data to identify one or more threats; and
a processor operably coupled to the memory and configured to:
collect a first data set comprising the external security framework, the one or more internal security requirements, and the one or more internal security controls from a database, wherein each of the external security framework, the one or more internal security requirements, and the one or more internal security controls includes one or more security policies associated with one or more organizational resources;
collect a second data set comprising the external threat data, wherein the external threat data comprises one or more historical malicious operations associated with the one or more security policies;
annotate the one or more security policies to create a modified first data set, wherein the one or more security policies are annotated with one or more annotations and wherein the one or more annotations indicate the one or more security policies that are associated with the one or more historical malicious operations;
create a first training set comprising the first data set, the second data set, and the modified first data set;
train the AI algorithm in a first stage using the first training set;
create a second training set for a second stage of training, wherein the second training set comprising the first training set and incorrectly detected threats from the one or more threats after the first stage of training;
retrain the AI algorithm in a second stage using the second training set;
electronically receive threat metadata from one or more web data sources, wherein the threat metadata comprises a new malicious operation associated with a malicious source;
execute the AI algorithm with the threat metadata as input in order to identify one or more new threats associated with the one or more security policies as output, wherein the one or more new threats comprises a first new threat associated with a suspected security policy, wherein the suspected security policy comprises one or more resource operations that at least partially matches the new malicious operation; and
quarantine one or more software programs executed as part of the one or more resource operations of the suspected security policy, wherein the one or more software programs are quarantined by transferring the one or more software programs in a quarantine sector of the memory.

2. The system of claim 1, wherein the processor is further configured to:
in response to quarantining the one or more software programs, transform the suspected security policy to generate a sanitized version of the suspected security policy by eliminating the one or more resource operations that at least partially matches the new malicious operation; and
in response to generating the sanitized version of the suspected security policy, transfer the quarantined one or more software programs out from the quarantine sector into a software program database, wherein the software program database is part of the one or more organizational resources.

3. The system of claim 1, wherein the processor is further configured to:
in response to quarantining the one or more software programs, identify a first organizational resource from the one or more organizational resources that accessed the one or more software programs within a past threshold time period; and
in response to identifying the first organizational resource accessed the one or more software programs within the past threshold time period, quarantine the first organizational resource by blocking access to any communication with the first organizational resource.

4. The system of claim 1, wherein the new malicious operation comprises a first organizational resource accessing a first cloud service provider, wherein the first organizational resource accessing the first cloud service provider is a first one of the one or more resource operations associated with the suspected security policy.

5. The system of claim 4, wherein the processor is further configured to:
transform the suspected security policy to generate a sanitized version of the suspected security policy by updating the first one of the one or more resource operations with the suspected security policy, wherein updating the first one of the one or more resource operations comprises the first organizational resource accessing a second cloud service provider and blocking access to first cloud service provider by the first organizational resource.

6. The system of claim 1, wherein the new malicious operation comprises creating a temporary guest profile to gain access to a first organizational resource of one or more organizational resources, wherein creating the temporary guest profile is a first one of the one or more resource operations associated with the suspected security policy.

7. The system of claim 6, wherein the processor is further configured to:
transform the suspected security policy to generate a sanitized version of the suspected security policy by eliminating the first one of the one or more resource operations of creating the temporary guest profile from the one or more resource operations associated with the suspected security policy.

8. A method comprising:
collecting a first data set comprising an external security framework, one or more internal security requirements, and one or more internal security controls from a database, wherein each of the external security framework, the one or more internal security requirements, and the one or more internal security controls includes one or more security policies associated with one or more organizational resources;
collecting a second data set comprising an external threat data, wherein the external threat data comprises one or more historical malicious operations associated with the one or more security policies;
annotating the one or more security policies to create a modified first data set, wherein the one or more security policies are annotated with one or more annotations and wherein the one or more annotations indicate the one or more security policies that are associated with the one or more historical malicious operations;
creating a first training set comprising the first data set, the second data set, and the modified first data set;
training an artificial intelligence (AI) algorithm in a first stage using the first training set;
creating a second training set for a second stage of training, wherein the second training set comprising the first training set and incorrectly detected threats from one or more threats after the first stage of training;
retraining the AI algorithm in a second stage using the second training set;
electronically receiving threat metadata from one or more web data sources, wherein the threat metadata comprises a new malicious operation associated with a malicious source;
executing the AI algorithm with the threat metadata as input in order to identify one or more new threats associated with the one or more security policies as output, wherein the one or more new threats comprises a first new threat associated with a suspected security policy, wherein the suspected security policy comprises one or more resource operations that at least partially matches the new malicious operation; and
quarantining one or more software programs executed as part of the one or more resource operations of the suspected security policy, wherein the one or more software programs are quarantined by transferring the one or more software programs in a quarantine sector of a memory.

9. The method of claim 8, further comprising:
in response to quarantining the one or more software programs, transforming the suspected security policy to generate a sanitized version of the suspected security policy by eliminating the one or more resource operations that at least partially matches the new malicious operation; and
in response to generating the sanitized version of the suspected security policy, transferring the quarantined one or more software programs out from the quarantine sector into a software program database, wherein the software program database is part of the one or more organizational resources.

10. The method of claim 8, further comprising:
in response to quarantining the one or more software programs, identifying a first organizational resource from the one or more organizational resources that accessed the one or more software programs within a past threshold time period; and
in response to identifying the first organizational resource accessed the one or more software programs within the past threshold time period, quarantining the first organizational resource by blocking access to any communication with the first organizational resource.

11. The method of claim 8, wherein the new malicious operation comprises a first organizational resource accessing a first cloud service provider, wherein the first organizational resource accessing the first cloud service provider is a first one of the one or more resource operations associated with the suspected security policy.

12. The method of claim 11, further comprising:
transforming the suspected security policy to generate a sanitized version of the suspected security policy by updating the first one of the one or more resource operations with the suspected security policy, wherein updating the first one of the one or more resource operations comprises the first organizational resource accessing a second cloud service provider and blocking access to first cloud service provider by the first organizational resource.

13. The method of claim 8, wherein the new malicious operation comprises creating a temporary guest profile to gain access to a first organizational resource of one or more organizational resources, wherein creating the temporary guest profile is a first one of the one or more resource operations associated with the suspected security policy.

14. The method of claim 13, further comprising:
transforming the suspected security policy to generate a sanitized version of the suspected security policy by eliminating the first one of the one or more resource operations of creating the temporary guest profile from the one or more resource operations associated with the suspected security policy.

15. A non-transitory computer-readable medium storing instructions that, when executed by a processor, cause the processor to:
collect a first data set comprising an external security framework, one or more internal security requirements, and one or more internal security controls from a database, wherein each of the external security framework, the one or more internal security requirements, and the one or more internal security controls includes one or more security policies associated with one or more organizational resources;
collect a second data set comprising an external threat data, wherein the external threat data comprises one or more historical malicious operations associated with the one or more security policies;
annotate the one or more security policies to create a modified first data set, wherein the one or more security policies are annotated with one or more annotations and wherein the one or more annotations indicate the one or more security policies that are associated with the one or more historical malicious operations;
create a first training set comprising the first data set, the second data set, and the modified first data set;
train an artificial intelligence (AI) algorithm in a first stage using the first training set;
create a second training set for a second stage of training, wherein the second training set comprising the first training set and incorrectly detected threats from one or more threats after the first stage of training;
retrain the AI algorithm in a second stage using the second training set;
electronically receive threat metadata from one or more web data sources, wherein the threat metadata comprises a new malicious operation associated with a malicious source;
execute the AI algorithm with the threat metadata as input in order to identify one or more new threats associated with the one or more security policies as output, wherein the one or more new threats comprises a first new threat associated with a suspected security policy, wherein the suspected security policy comprises one or more resource operations that at least partially matches the new malicious operation; and
quarantine one or more software programs executed as part of the one or more resource operations of the suspected security policy, wherein the one or more software programs are quarantined by transferring the one or more software programs in a quarantine sector of a memory.

16. The non-transitory computer-readable medium of claim 15, wherein the instructions further cause the processor to:
in response to quarantining the one or more software programs, transform the suspected security policy to generate a sanitized version of the suspected security policy by eliminating the one or more resource operations that at least partially matches the new malicious operation; and
in response to generating the sanitized version of the suspected security policy, transfer the quarantined one or more software programs out from the quarantine sector into a software program database, wherein the software program database is part of the one or more organizational resources.

17. The non-transitory computer-readable medium of claim 15, wherein the instructions further cause the processor to:
in response to quarantining the one or more software programs, identify a first organizational resource from the one or more organizational resources that accessed the one or more software programs within a past threshold time period; and
in response to identifying the first organizational resource accessed the one or more software programs within the past threshold time period, quarantine the first organizational resource by blocking access to any communication with the first organizational resource.

18. The non-transitory computer-readable medium of claim 15, wherein the new malicious operation comprises a first organizational resource accessing a first cloud service provider, wherein the first organizational resource accessing the first cloud service provider is a first one of the one or more resource operations associated with the suspected security policy.

19. The non-transitory computer-readable medium of claim 18, wherein the instructions further cause the processor to:
transform the suspected security policy to generate a sanitized version of the suspected security policy by updating the first one of the one or more resource operations with the suspected security policy, wherein updating the first one of the one or more resource operations comprises the first organizational resource accessing a second cloud service provider and blocking access to first cloud service provider by the first organizational resource.

20. The non-transitory computer-readable medium of claim 15, wherein the new malicious operation comprises creating a temporary guest profile to gain access to a first organizational resource of one or more organizational resources, wherein creating the temporary guest profile is a first one of the one or more resource operations associated with the suspected security policy.
